(19) United States
(12) Patent Application Publication
(10) Pub. No.: US 2026/0005964 A1
(43) Pub. Date: Jan. 1, 2026

(54) PACKET FORWARDING METHOD AND DEVICE BASED ON CLOUD NETWORK

(71) Applicant: Beijing Volcano Engine Technology Co., Ltd., Beijing (CN)

(72) Inventors: Junjie LI, Beijing (CN); Xinyu QIAN, Beijing (CN); Deguo LI, Beijing (CN); Brian HUANG, Beijing (CN); Shubo WEN, Beijing (CN)

(21) Appl. No.: 19/171,595

(22) Filed: Apr. 7, 2025

(30) Foreign Application Priority Data
Jun. 28, 2024 (CN) 202410870053.2

(51) Int. Cl. H04L 45/76

(52) U.S. Cl. CPC H04L 45/76; H04L 2212/00

(57) ABSTRACT

Embodiments of the present disclosure provide a packet forwarding method and device based on a cloud network, the method including: receiving a first packet sent by a source virtual machine to a destination virtual machine, parsing the first packet, replacing an Ethernet protocol header of the first packet with a preset private extension protocol header, setting each field in the private extension protocol header according to a business requirement, and performing encapsulation through a VXLAN protocol to generate a second packet; and forwarding the target traffic based on the second packet.

### CROSS-REFERENCE TO RELATED APPLICATION

This application claims priority to Chinese Application No. 202410870053.2 filed on Jun. 28, 2024, the disclosure of which is incorporated herein by reference in its entirety.

### FIELD

Embodiments of the present disclosure relate to the field of computer and network communication technologies, and in particular, to a packet forwarding method and device based on a cloud network.

### BACKGROUND

In the current implementation of a cloud network, business traffic of a tenant is usually isolated and encapsulated using a VXLAN (Virtual Extensible Local Area Network, network virtualization technology) protocol, and then transmitted between different computing nodes and network elements.

### SUMMARY

Embodiments of the present disclosure provide a packet forwarding method and device based on a cloud network.

According to a first aspect, an embodiment of the present disclosure provides a packet forwarding method based on a cloud network, including:
receiving a first packet sent by a source virtual machine to a destination virtual machine, where the first packet is generated by encapsulating target traffic based on an Ethernet protocol;
parsing the first packet, replacing an Ethernet protocol header of the first packet with a preset private extension protocol header, setting each field in the private extension protocol header according to a business requirement, and performing encapsulation through a virtual extensible local area network (VXLAN) protocol to generate a second packet; and
forwarding the target traffic based on the second packet.

According to a second aspect, an embodiment of the present disclosure provides a packet forwarding device based on a cloud network, including:
a receiving unit, configured to receive a first packet sent by a source virtual machine to a destination virtual machine, where the first packet is generated by encapsulating target traffic based on an Ethernet protocol;
a parsing unit, configured to parse the first packet, replace an Ethernet protocol header of the first packet with a preset private extension protocol header, set each field in the private extension protocol header according to a business requirement, and perform encapsulation through a virtual extensible local area network (VXLAN) protocol to generate a second packet; and
a forwarding unit, configured to forward the target traffic based on the second packet.

According to a third aspect, an embodiment of the present disclosure provides an electronic device, including: a processor and a memory, where
the memory stores computer-executable instructions; and
the processor executes the computer-executable instructions stored in the memory, to enable the at least one processor to perform the packet forwarding method based on a cloud network according to the first aspect and various possible designs of the first aspect.

According to a fourth aspect, an embodiment of the present disclosure provides a computer-readable storage medium. The computer-readable storage medium stores computer-executable instructions, and a processor, when executing the computer-executable instructions, implements the packet forwarding method based on a cloud network according to the first aspect and various possible designs of the first aspect.

According to a fifth aspect, an embodiment of the present disclosure provides a computer program product, including a computer program. The computer program, when executed by a processor, implements the packet forwarding method based on a cloud network according to the first aspect and various possible designs of the first aspect.

### BRIEF DESCRIPTION OF THE DRAWINGS

In order to more clearly illustrate the technical solutions in the embodiments of the present disclosure or in the prior art, the following will briefly introduce the drawings that need to be used in the description of the embodiments or the prior art. Obviously, the drawings in the following description are some embodiments of the present disclosure, and those of ordinary skill in the art can obtain other drawings according to these drawings without paying creative labor.

FIG. 1 is a schematic diagram of an application scenario of the packet forwarding method based on the cloud network according to an embodiment of the present disclosure;

FIG. 2 is a first flowchart of the packet forwarding method based on the cloud network according to an embodiment of the present disclosure;

FIG. 3 is a first schematic diagram of the packet forwarding method based on the cloud network according to an embodiment of the present disclosure;

FIG. 4 is a second schematic diagram of the packet forwarding method based on the cloud network according to an embodiment of the present disclosure;

FIG. 5 is a first schematic diagram of a second packet according to an embodiment of the present disclosure;

FIG. 6 is a schematic diagram of a structure of a packet forwarding device based on a cloud network according to an embodiment of the present disclosure; and

FIG. 7 is a schematic diagram of a structure of an electronic device according to an embodiment of the present disclosure.

### DETAILED DESCRIPTION OF EMBODIMENTS

In order to make the objectives, technical solutions, and advantages of the embodiments of the present disclosure clearer, the technical solutions in the embodiments of the present disclosure will be described clearly and comprehensively below with reference to the drawings in the embodiments of the present disclosure. Obviously, the described embodiments are part of the embodiments of the present disclosure, but not all of them. Based on the embodiments in the present disclosure, all other embodiments obtained by those of ordinary skill in the art without creative labor belong to the protection scope of the present disclosure.

The technical terms and technical background involved in the embodiments of the present disclosure are explained below.

In the current implementation of a cloud network, business traffic of a tenant is usually isolated and encapsulated using a VXLAN (Virtual Extensible Local Area Network, network virtualization technology) protocol, and then transmitted between different computing nodes and network elements. The business traffic of the tenant is called overlay traffic, and the network to which the tenant belongs is called an overlay network. The computing node and the network element transmit the overlay traffic after encapsulating the overlay traffic through the VXLAN protocol. The encapsulated traffic is called underlay traffic, and the network between the computing node and the network element is called an underlay network.

In the underlay network based on VXLAN, a node that supports encapsulation and decapsulation according to the VXLAN protocol and can exchange traffic with other computing nodes or network elements through the VXLAN protocol is called a VTEP (VXLAN Tunnel Endpoint).

In the overlay network, a TCP/IP protocol stack based on the Ethernet protocol is usually applied, and the outermost layer of all business traffic is the Ethernet protocol. In a traditional physical network, the Ethernet protocol belongs to the second layer of an OSI (Open Systems Interconnection) network model. The network protocol stack performs neighbor discovery based on an ARP/ND protocol, and after finding a route, sends a packet to a switch by specifying a next hop through a MAC address (Media Access Control Address, Ethernet address). The switch forwards traffic based on the MAC address in the Ethernet protocol. In a public cloud scenario, most implementations of a virtual switch (vSwitch) omit the logic of Layer 2 forwarding, and use a control packet answer technology instead of a neighbor discovery function of ARP/ND to directly use a Layer 3 IP address of business traffic for traffic forwarding. The ARP/ND answer technology uses a virtual MAC to answer all ARP/ND requests from virtual machines, which allows business traffic in all virtual machines to be sent from a protocol stack normally, and finally forwarded to a computing node. At this time, the computing node performs VXLAN encapsulation on the business traffic according to information such as a route, and then sends the traffic to a destination VTEP.

In a process of traffic transmission between a computing node and a network element, some business information usually needs to be identified or carried in traffic. In complex scenarios of a cloud network, some business information usually needs to be identified or carried between VTEPs. In the prior art, a reserved field of the VXLAN protocol is usually used for identification. However, the reserved field defined by the VXLAN protocol has only 32 bits, and can store a relatively small amount of information. When traffic is transmitted between a computing node and a network element, a technical problem of limited expansion due to insufficient reserved fields is often faced.

In view of the technical problem of insufficient reserved fields in the prior art, inventors' technical concept is as follows. After a packet of the Ethernet protocol is sent from a virtual machine to a vSwitch, the vSwitch parses a source MAC of the packet, and then the packet is transmitted between VTEPs. In this transmission process, an Ethernet protocol header does not participate in a traffic forwarding decision, and does not affect a traffic forwarding process. Therefore, the Ethernet protocol header may be replaced to convert the packet of the Ethernet protocol into a packet of a private extension protocol, and more business information is carried through the packet of the private extension protocol.

Accordingly, the specific steps may include: firstly, receiving a first packet sent by a source virtual machine to a destination virtual machine, where the first packet is generated by encapsulating target traffic based on an Ethernet protocol; then, parsing the first packet, replacing an Ethernet protocol header of the first packet with a preset private extension protocol header, setting each field in the private extension protocol header according to a business requirement, and encapsulating, through a virtual extensible local area network (VXLAN) protocol, the first packet to generate a second packet; and finally, forwarding the target traffic based on the second packet.

In this technical solution, the Ethernet protocol header of the first packet is replaced with the preset private extension protocol header, and the fields in the private extension protocol header may store business information. In this way, when the target traffic is forwarded based on the second packet, more business information may be stored, thereby improving the amount of business information that can be carried in the packet, and thus solving the technical problem of limited expansion due to insufficient reserved fields of a tunnel protocol header (VXLAN) in the prior art.

The application scenario of the embodiments of the present disclosure is explained below.

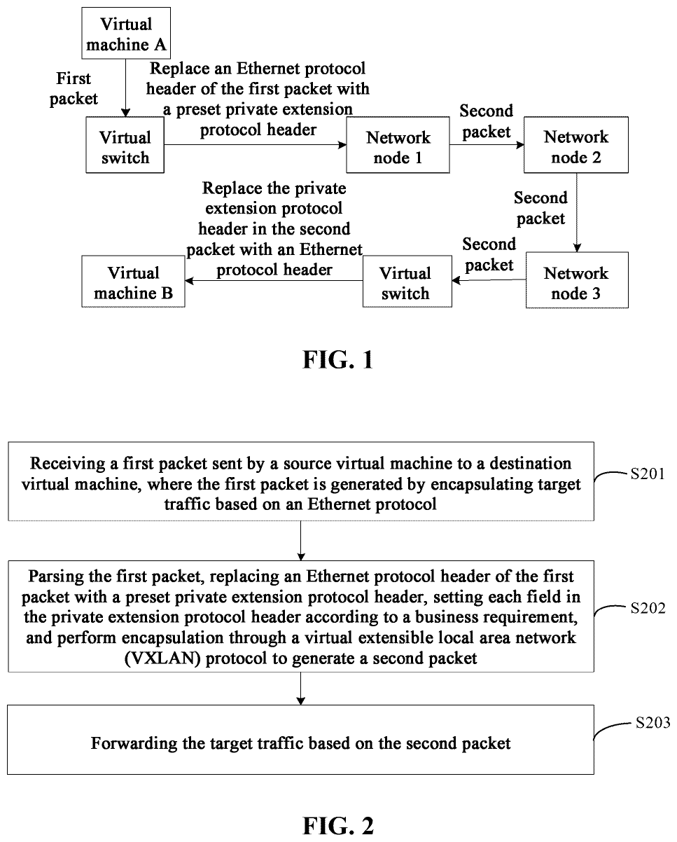

The packet forwarding method based on a cloud network provided in the embodiments of the present disclosure may be applied to a business information transmission scenario between various network nodes. FIG. 1 is a schematic diagram of an application scenario of the packet forwarding method based on the cloud network according to an embodiment of the present disclosure. As shown in FIG. 1, a virtual machine A sends a first packet to a virtual switch (vSwitch) based on an Ethernet protocol. The vSwitch replaces an Ethernet protocol header of the first packet with a preset private extension protocol header, configures each field in the private extension protocol header according to business requirement information, and encapsulates the first packet through a VXLAN protocol to obtain a second packet. The second packet including the private extension protocol header is forwarded between multiple network nodes. More business information may be carried through the private extension protocol header in the second packet, thereby solving the technical problem of limited expansion due to insufficient reserved fields of a tunnel protocol header (VXLAN) between multiple network nodes. After that, a last network node 3 forwards the second packet to the virtual switch. The virtual switch decapsulates the VXLAN protocol of the second packet, replaces the private extension protocol header in the second packet with an Ethernet protocol header to obtain a third packet, and sends the third packet to a virtual machine B, to implement network communication between the virtual machine A and the virtual machine B.

The following is a specific implementation process of the packet forwarding method and device based on a cloud network according to the embodiments of the present disclosure. Some examples are only for illustration and are not intended to limit the present disclosure. An execution body of the packet forwarding method based on a cloud network according to the embodiments of the present disclosure is an electronic device, which may be a computer, a mobile phone, a tablet, a server, or the like.

FIG. 2 is a first flowchart of the packet forwarding method based on the cloud network according to an embodiment of the present disclosure. As shown in FIG. 2, the packet forwarding method based on a cloud network may include the following steps.

S201: A first packet sent by a source virtual machine to a destination virtual machine is received, where the first packet is generated by encapsulating target traffic based on an Ethernet protocol.

In the embodiment of the present disclosure, the first packet may be isolated and encapsulated through a VXLAN (Virtual Extensible Local Area Network, network virtualization technology) protocol, and then transmitted between different computing nodes and network elements.

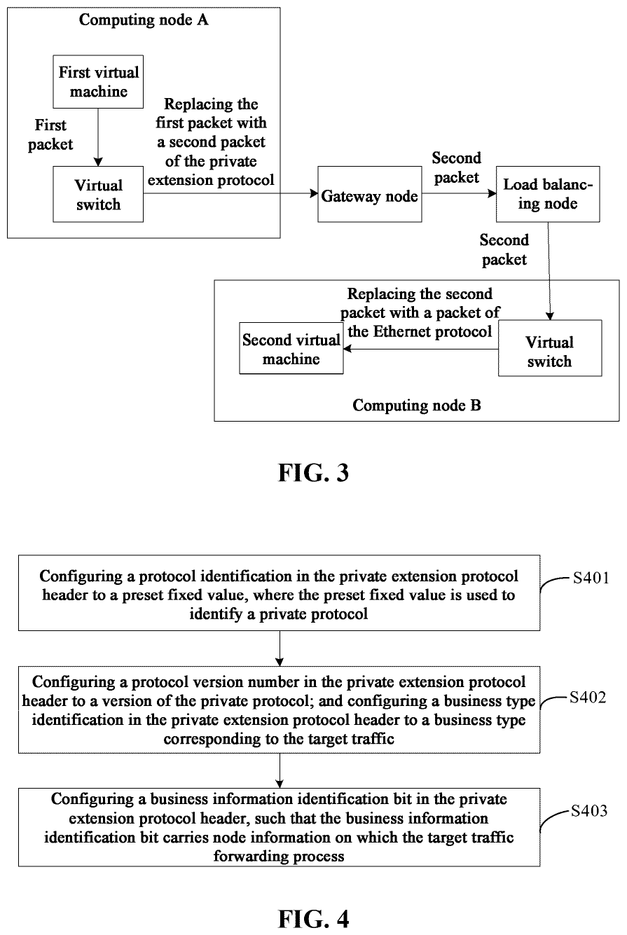

Optionally, the source virtual machine may be a virtual machine in a first computing node, and the destination virtual machine may be a virtual machine in a second computing node. The first computing node and the second computing node are different computing nodes. Exemplarily, as shown in FIG. 3, the source virtual machine is a first virtual machine in a computing node A, and the destination virtual machine is a second virtual machine in a computing node B.

S202: The first packet is parsed, an Ethernet protocol header of the first packet is replaced with a preset private extension protocol header, each field in the private extension protocol header is set according to a business requirement, and encapsulation is performed through a virtual extensible local area network (VXLAN) protocol to generate a second packet.

In the embodiment of the present disclosure, the first packet may be parsed by the virtual switch in the first computing node, the Ethernet protocol header of the first packet is replaced with the preset private extension protocol header, and the each field in the private extension protocol header are set according to the a business requirement, to implement the coverage of the second packet of the private extension protocol to the first packet of the Ethernet protocol, and then the second packet of the private extension protocol may be transmitted between multiple network nodes.

Optionally, the private extension protocol header includes a protocol identification, a protocol version identification, a traffic type identification, a business identification, and a storable field for storing business information.

It should be noted that the length (number of bytes included) of the private extension protocol header is the same as that of the Ethernet protocol header. Exemplarily, the length of the Ethernet protocol header is 14 bytes, and the length of the private extension protocol header is also 14 bytes (112 bits). The protocol identification in the private extension protocol header includes 8 bits, the protocol version identification includes 4 bits, the type identification includes 8 bits, multiple business information identification bits in the business identification include 12 bits, and the storable field includes 80 bits.

In some embodiments, the business identification includes multiple business information identification bits. Exemplarily, the business identification may include 12 bits of information, that is, 12 business information identification bits. The 12 business information identification bits are CLGRRRVMRRRR in sequence. R is a reserved field, and business information identification bit related to any business to be expanded may be added. C is a business information identification bit corresponding to a computing node, and may be represented as 0×800 (hexadecimal). L is a business information identification bit corresponding to a load balancing node, and may be represented as 0×400 (hexadecimal). G is a business information identification bit corresponding to a gateway node, and may be represented as 0×200 (hexadecimal). V is a business information identification bit corresponding to a VNI, and may be represented as 0×20 (hexadecimal). M is a business information identification bit corresponding to a MAC, and may be represented as 0×10 (hexadecimal).

In the embodiment of the present disclosure, more business information may be carried through the private extension protocol header of the second packet.

S203: The target traffic based on the second packet is forwarded.

In the embodiment of the present disclosure, the second packet may be forwarded to a next VTEP based on a forwarding path topology. On each forwarding path, the VTEP is configured to parse the packet to obtain the private extension protocol header, and support changing a field in the private extension protocol header or executing business logic according to its own business requirement.

In some embodiments, each VTEP may parse the first packet to obtain routing information corresponding to the first packet. Then, the next VTEP that receives the first packet is determined through the routing information, to implement forwarding the second packet to the next VTEP based on the forwarding path topology.

In some embodiments, on each forwarding path, the VTEP is configured to support changing a business information identification bit corresponding to a node identification in the private extension protocol header according to its own node identification.

Optionally, the VTEP on the forwarding path may be a network node. Accordingly, the step in which on each forwarding path, the VTEP is configured to parse the packet to obtain the private extension protocol header, and support changing a field in the private extension protocol header or executing business logic according to its own business requirement includes: on each forwarding path, the VTEP is configured to set a business information identification bit corresponding to a node identification of the network node in the business identification to 1 according to the node identification of the network node, re-set a business information identification bit corresponding to a node identification of a previous network node in the business identification to 0, and set a business information identification bit corresponding to the VNI to 1 according to the VNI corresponding to the first virtual machine, and store the VNI in the storable field of the private extension protocol header; and set a business information identification bit corresponding to the MAC to 1 according to the MAC corresponding to the second virtual machine, and store the MAC in the storable field of the private extension protocol header.

Exemplarily, as shown in FIG. 3, the VTEP is a network node on a forwarding path between the computing node A and the computing node B. The computing node A includes a first virtual machine for data processing and a virtual switch for data transmission. The computing node forwards the second packet to a first network node (a gateway node) through the virtual switch. The gateway node re-sets an identification field (0×800) corresponding to the computing node in the private extension protocol header to 0, and sets an identification field (0×200) corresponding to the gateway node in the private extension protocol header to 1.

The gateway node forwards the second packet to a next network node (a load balancing node). The load balancing node sets an identification field (0×200) corresponding to the gateway node in the private extension protocol header to 0, and sets an identification field (0×400) corresponding to the load balancing node in the private extension protocol header to 1.

It should be noted that each computing node may further receive and parse a third packet of the private extension protocol, replace a private extension protocol header in the third packet with an Ethernet protocol header, set a source MAC thereof to a virtual MAC of the virtual switch and set a destination MAC to a MAC of a tenant network card to generate a fourth packet, and forward the fourth packet to the destination virtual machine.

The third packet of the private extension protocol may be any packet based on the private extension protocol. For example, the third packet of the private extension protocol may be the second packet in the embodiment of FIG. 3. Exemplarily, as shown in FIG. 3, when the last network node sends the second packet to the computing node B, the second packet is replaced with a packet of the Ethernet protocol through the virtual switch in the computing node B, and the packet of the Ethernet protocol is sent to the second virtual machine in the computing node B. Optionally, the virtual switch of the computing node B may obtain the MAC address of the second virtual machine from a local configuration on the computing node B, and send the packet of the Ethernet protocol to the second virtual machine through the MAC address of the second virtual machine.

According to the packet forwarding method based on a cloud network provided in the embodiment of the present disclosure, the method includes: receiving a first packet sent by a source virtual machine to a destination virtual machine, where the first packet is generated by encapsulating target traffic based on an Ethernet protocol; parsing the first packet, replacing an Ethernet protocol header of the first packet with a preset private extension protocol header, setting each field in the private extension protocol header according to a business requirement, and encapsulating, through a virtual extensible local area network (VXLAN) protocol, the first packet to generate a second packet; and forwarding the target traffic based on the second packet. In this technical solution, the Ethernet protocol header of the first packet is replaced with the preset private extension protocol header, and the fields in the private extension protocol header may store business information. In this way, when the target traffic is forwarded based on the second packet, more business information may be stored, thereby improving the amount of business information that can be carried in the packet, and thus solving the technical problem of limited expansion due to insufficient reserved fields of a tunnel protocol header (VXLAN) in the prior art.

FIG. 4 is a second flowchart of the packet forwarding method based on the cloud network according to an embodiment of the present disclosure. In the embodiment of the present disclosure, a specific method for setting each field in the private extension protocol header according to the business requirement in step S202 is explained. As shown in FIG. 4, the method includes the following steps.

S401: A protocol identification in the private extension protocol header is configured to a preset fixed value, where the preset fixed value is used to identify a private protocol.

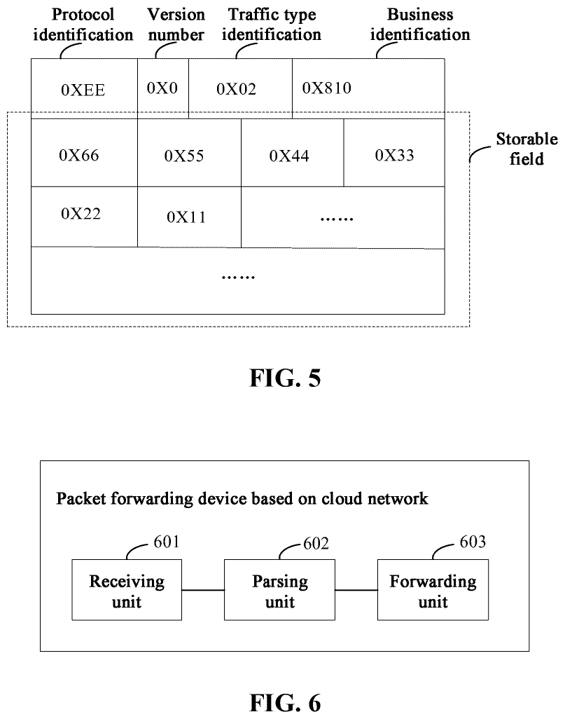

Exemplarily, as shown in FIG. 5, a protocol identification of the private extension protocol is 0×EE, representing the private extension protocol. A protocol version identification is 0×0, representing version number 0.

S402: A protocol version number in the private extension protocol header is configured to a version of the private protocol; and a business type identification in the private extension protocol header is configured to a business type corresponding to the target traffic.

In some embodiments, the traffic type identification includes multiple values in a preset value range, and one value corresponds to one traffic type identification. In the embodiment of the present disclosure, the preset value range is not specifically limited. Optionally, the preset value range is determined by the size of a type identification field. Exemplarily, if the size of the type identification field is 8 bits, the preset value range is [0, 0×FF].

Optionally, the step of configuring the business type identification in the private extension protocol header to the business type corresponding to the target traffic includes: if the business type corresponding to the target traffic is a no-type, configuring the business type identification in the private extension protocol header to 0×00; if the business type corresponding to the target traffic is a traffic mirror type, configuring the business type identification in the private extension protocol header to 0×01; and if the business type corresponding to the target traffic is a cross-network traffic type, configuring the business type identification in the private extension protocol header to 0×02, where the cross-network traffic type includes a cross-Virtual Private Cloud (VPC) network traffic type.

Exemplarily, as shown in FIG. 5, the type identification in the private extension protocol header is 0×02, representing the cross-network traffic type.

S403: A business information identification bit in the private extension protocol header is configured, such that the business information identification bit carries node information on which the target traffic forwarding process depends.

In the embodiment of the present disclosure, each business information identification bit corresponds to one type of business information. The virtual switch in the computing node or each VTEP in the forwarding process may configure the business information identification bit in the private extension protocol header according to the node information on which the forwarding process depends.

Optionally, the node information on which the computing node A depends in the forwarding process includes: a node identification of the computing node A, a VNI (VXLAN Network Identifier) corresponding to the first virtual machine in the computing node A, and an Ethernet address MAC corresponding to the second virtual machine in the computing node B.

Accordingly, this step may include: setting a business information identification bit corresponding to the first computing node in the business identification to 1 according to the node identification of the first computing node, and setting a business information identification bit corresponding to the VNI to 1 according to the VNI corresponding to the first virtual machine, and storing the VNI in the storable field of the private extension protocol header; and setting a business information identification bit corresponding to the MAC to 1 according to the MAC corresponding to the second virtual machine, and storing the MAC in the storable field of the private extension protocol header.

Exemplarily, as shown in FIG. 5, the business identification is 0×810. At this time, the business information identification bit corresponding to the computing node is set to 1, representing that the traffic comes from the computing node; and the business information identification bit corresponding to the MAC is set to 1, representing that MAC address information needs to be transmitted. The MAC address information that needs to be transmitted is 66:55:44:33:22:11, which is stored in the first 6 bytes of the storable field.

FIG. 6 is a schematic diagram of a structure of the packet forwarding device based on the cloud network according to an embodiment of the present disclosure. As shown in FIG. 6, the packet forwarding device based on a cloud network includes:
a receiving unit 601, configured to receive a first packet sent by a source virtual machine to a destination virtual machine, where the first packet is generated by encapsulating target traffic based on an Ethernet protocol;
a parsing unit 602, configured to parse the first packet, replace an Ethernet protocol header of the first packet with a preset private extension protocol header, set each field in the private extension protocol header according to a business requirement, and perform encapsulation through a virtual extensible local area network (VXLAN) protocol to generate a second packet; and
a forwarding unit 603, configured to forward the target traffic based on the second packet.

According to one or more embodiments of the present disclosure, the private extension protocol header includes a protocol identification, a protocol version identification, a traffic type identification, a business identification, and a storable field for storing business information.

According to one or more embodiments of the present disclosure, the step in which the parsing unit 602 sets each field in the private extension protocol header according to the business requirement specifically includes: configuring the protocol identification in the private extension protocol header to a preset fixed value, where the preset fixed value is used to identify a private protocol; configuring a protocol version number in the private extension protocol header to a version of the private protocol; configuring a business type identification in the private extension protocol header to a business type corresponding to the target traffic; and configuring a business information identification bit in the private extension protocol header, such that the business information identification bit carries node information on which the target traffic forwarding process depends.

According to one or more embodiments of the present disclosure, the parsing unit 602 is further configured to receive and parse a third packet, replace a private extension protocol header in the third packet with an Ethernet protocol header, set a source MAC thereof to a virtual MAC of a virtual switch and set a destination MAC to a MAC of a tenant network card to generate a fourth packet, and forward the fourth packet to the destination virtual machine.

According to one or more embodiments of the present disclosure, the step in which the forwarding unit 603 forwards the target traffic based on the second packet includes: forwarding the second packet to a next VXLAN-protocol-based VTEP based on a forwarding path topology, where on each forwarding path, the VTEP is configured to parse the packet to obtain the private extension protocol header, and support changing a field in the private extension protocol header or executing business logic according to its own business requirement.

According to one or more embodiments of the present disclosure, the forwarding unit is further configured to, on each forwarding path, the VTEP is configured to: on each forwarding path, the VTEP is configured to support changing a business information identification bit corresponding to a node identification in the private extension protocol header according to its own node identification.

According to one or more embodiments of the present disclosure, the traffic type identification includes multiple values in a preset value range, and one value corresponds to one traffic type identification. Accordingly, the step in which the parsing unit 602 configures the business type identification in the private extension protocol header to the business type corresponding to the target traffic specifically includes: if the business type corresponding to the target traffic is a no-type, configuring the business type identification in the private extension protocol header to 0×00; if the business type corresponding to the target traffic is a traffic mirror type, configuring the business type identification in the private extension protocol header to 0×01; and if the business type corresponding to the target traffic is a cross-network traffic type, configuring the business type identification in the private extension protocol header to 0×02, where the cross-network traffic type includes a cross-Virtual Private Cloud (VPC) network traffic type.

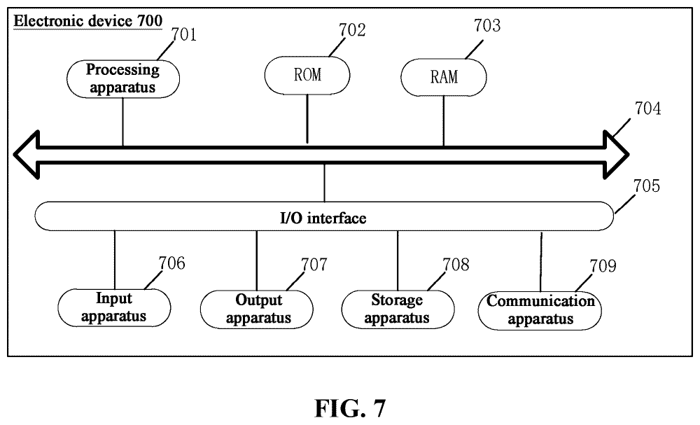

Referring to FIG. 7, it shows a schematic diagram of a structure of an electronic device 700 suitable for implementing the embodiments of the present disclosure. The electronic device 700 may be a terminal device or a server. The terminal device may include, but is not limited to, mobile terminals such as a mobile phone, a laptop, a digital broadcast receiver, a personal digital assistant (abbreviated as PDA), a tablet computer, a portable media player (abbreviated as PMP), a vehicle-mounted terminal (such as a vehicle-mounted navigation terminal), and fixed terminals such as a digital TV and a desktop computer. The electronic device shown in FIG. 7 is only an example, and should not bring any limitation to the function and scope of use of the embodiments of the present disclosure.

As shown in FIG. 7, the electronic device 700 may include a processing apparatus (such as a central processing unit and a graphics processor) 701. The processing apparatus may perform various appropriate actions and processing according to a program stored in a Read-Only Memory (abbreviated as ROM) 702 or a program loaded from a storage apparatus 708 into a Random Access Memory (abbreviated as RAM) 703. The RAM 703 further stores various programs and data required for the operation of the electronic device 700. The processing apparatus 701, the ROM 702, and the RAM 703 are connected to each other through a bus 704. An input/output (I/O) interface 705 is also connected to the bus 704.

Generally, the following apparatus may be connected to the I/O interface 705: an input apparatus 706, including, for example, a touchscreen, a touchpad, a keyboard, a mouse, a camera, a microphone, an accelerometer, a gyroscope, or the like; an output apparatus 707, including, for example, a liquid crystal display (abbreviated as LCD), a speaker, a vibrator, or the like; the storage apparatus 708, including, for example, a magnetic tape, a hard disk, or the like; and a communication apparatus 709. The communication apparatus 709 may allow the electronic device 700 to perform wireless or wired communication with other devices to exchange data. Although FIG. 7 shows the electronic device 700 having various apparatuses, it should be understood that not all of the illustrated apparatuses are necessarily implemented or provided. More or fewer apparatuses may be implemented or provided alternatively.

In particular, according to the embodiments of the present disclosure, the process described above with reference to the flowchart may be implemented as a computer software program. For example, an embodiment of the present disclosure includes a computer program product, which includes a computer program carried on a computer-readable medium, and the computer program includes program codes for performing the method shown in the flowchart. In such an embodiment, the computer program may be downloaded and installed from the network through the communication apparatus 709, or installed from the storage apparatus 708, or installed from the ROM 702. When the computer program is executed by the processing apparatus 701, the above-mentioned functions defined in the method of the embodiments of the present disclosure are executed.

It should be noted that the above-mentioned computer-readable medium in the present disclosure may be a computer-readable signal medium or a computer-readable storage medium, or any combination thereof. The computer-readable storage medium may be, for example, but not limited to, an electrical, magnetic, optical, electromagnetic, infrared, or semiconductor system, apparatus, or component, or any combination thereof. More specific examples of the computer-readable storage medium may include, but are not limited to: an electrical connection with one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium that contains or stores a program, and the program may be used by or in combination with an instruction execution system, apparatus, or component. In the present disclosure, the computer-readable signal medium may include a data signal propagated in a baseband or as a part of a carrier wave, and computer-readable program codes are carried in the data signal. The data signal propagated in this manner may take a variety of forms, including but not limited to an electromagnetic signal, an optical signal, or any suitable combination thereof. The computer-readable signal medium may also be any computer-readable medium other than the computer-readable storage medium. The computer-readable signal medium may send, propagate, or transmit the program for use by or in combination with the instruction execution system, apparatus, or component. The program codes contained in the computer-readable medium may be transmitted using any suitable medium, including but not limited to an electrical wire, an optical cable, radio frequency (RF), or any suitable combination thereof.

The above-mentioned computer-readable medium may be included in the above-mentioned electronic device, or may exist alone without being assembled into the electronic device.

The above-mentioned computer-readable medium carries one or more programs, and when the above-mentioned one or more programs are executed by the electronic device, the electronic device is caused to execute the method shown in the above-mentioned embodiments.

The computer program codes for performing the operations in the present disclosure may be written in one or more programming languages or a combination thereof. The above-mentioned programming languages include object-oriented programming languages such as Java, Smalltalk, C++, and also conventional procedural programming languages such as “C” language or similar programming languages. The program codes may be executed entirely on the user's computer, partly on the user's computer, as a stand-alone software package, partly on the user's computer and partly on a remote computer, or entirely on the remote computer or server. In the scenario involving the remote computer, the remote computer may be connected to the user's computer through any type of network, including a Local Area Network (LAN for short) or a Wide Area Network (WAN for short), or the connection may be made to an external computer (for example, through the Internet using an Internet service provider).

The flowcharts and block diagrams in the drawings illustrate the architecture, functionality, and operation of possible implementations of systems, methods and computer program products according to various embodiments of the present disclosure. In this regard, each block in the flowcharts or block diagrams may represent a module, a program segment, or part of codes, including one or more executable instructions for implementing specified logical functions. It should also be noted that, in some alternative implementations, the functions noted in the blocks may occur out of the order noted in the drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The units described in the embodiments of the present disclosure may be implemented by software or hardware. The name of the unit does not constitute a limitation on the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, a machine-readable medium may be a tangible medium that may contain or store a program for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection with one or more wires, a portable computer disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof.

In a first aspect, one or more embodiments of the present disclosure provide a packet forwarding method based on a cloud network, including:
receiving a first packet sent by a source virtual machine to a destination virtual machine, where the first packet is generated by encapsulating target traffic based on an Ethernet protocol;
parsing the first packet, replacing an Ethernet protocol header of the first packet with a preset private extension protocol header, setting each field in the private extension protocol header according to a business requirement, and performing encapsulation through a virtual extensible local area network (VXLAN) protocol to generate a second packet; and
forwarding the target traffic based on the second packet.

According to one or more embodiments of the present disclosure, the private extension protocol header includes a protocol identification, a protocol version identification, a traffic type identification, a business identification, and a storable field for storing business information.

According to one or more embodiments of the present disclosure, the step of setting each field in the private extension protocol header according to the business requirement includes: configuring the protocol identification in the private extension protocol header to a preset fixed value, where the preset fixed value is used to identify a private protocol; configuring a protocol version number in the private extension protocol header to a version of the private protocol; configuring a business type identification in the private extension protocol header to a business type corresponding to the target traffic; and configuring a business information identification bit in the private extension protocol header, such that the business information identification bit carries node information on which the target traffic forwarding process depends.

According to one or more embodiments of the present disclosure, the method further includes: receiving and parsing a third packet, replacing a private extension protocol header in the third packet with an Ethernet protocol header, setting a source MAC thereof to a virtual MAC of a virtual switch and setting a destination MAC to a MAC of a tenant network card to generate a fourth packet, and forwarding the fourth packet to the destination virtual machine.

According to one or more embodiments of the present disclosure, the step of forwarding the target traffic based on the second packet includes: forwarding the second packet to a next VXLAN-protocol-based VTEP based on a forwarding path topology, where on each forwarding path, the VTEP is configured to parse the packet to obtain the private extension protocol header, and support changing a field in the private extension protocol header or executing business logic according to its own business requirement.

According to one or more embodiments of the present disclosure, the method further includes: on each forwarding path, the VTEP is configured to support changing a business information identification bit corresponding to a node identification in the private extension protocol header according to its own node identification.

According to one or more embodiments of the present disclosure, the traffic type identification includes multiple values in a preset value range, and one value corresponds to one traffic type identification. Accordingly, the step of configuring the business type identification in the private extension protocol header to the business type corresponding to the target traffic includes: if the business type corresponding to the target traffic is a no-type, configuring the business type identification in the private extension protocol header to 0×00; if the business type corresponding to the target traffic is a traffic mirror type, configuring the business type identification in the private extension protocol header to 0×01; and if the business type corresponding to the target traffic is a cross-network traffic type, configuring the business type identification in the private extension protocol header to 0×02, where the cross-network traffic type includes a cross-Virtual Private Cloud (VPC) network traffic type.

In a second aspect, one or more embodiments of the present disclosure provide a packet forwarding device based on a cloud network, including:
a receiving unit, configured to receive a first packet sent by a source virtual machine to a destination virtual machine, where the first packet is generated by encapsulating target traffic based on an Ethernet protocol;
a parsing unit, configured to parse the first packet, replace an Ethernet protocol header of the first packet with a preset private extension protocol header, set each field in the private extension protocol header according to a business requirement, and perform encapsulation through a virtual extensible local area network (VXLAN) protocol to generate a second packet; and
a forwarding unit, configured to forward the target traffic based on the second packet.

According to one or more embodiments of the present disclosure, the private extension protocol header includes a protocol identification, a protocol version identification, a traffic type identification, a business identification, and a storable field for storing business information.

According to one or more embodiments of the present disclosure, the step in which the parsing unit sets each field in the private extension protocol header according to the business requirement specifically includes: configuring the protocol identification in the private extension protocol header to a preset fixed value, where the preset fixed value is used to identify a private protocol; configuring a protocol version number in the private extension protocol header to a version of the private protocol; configuring a business type identification in the private extension protocol header to a business type corresponding to the target traffic; and configuring a business information identification bit in the private extension protocol header, such that the business information identification bit carries node information on which the target traffic forwarding process depends.

According to one or more embodiments of the present disclosure, the parsing unit is further configured to receive and parse a third packet, replace a private extension protocol header in the third packet with an Ethernet protocol header, set a source MAC thereof to a virtual MAC of a virtual switch and set a destination MAC to a MAC of a tenant network card to generate a fourth packet, and forward the fourth packet to the destination virtual machine.

According to one or more embodiments of the present disclosure, the step in which the forwarding unit forwards the target traffic based on the second packet includes: forwarding the second packet to a next VXLAN-protocol-based VTEP based on a forwarding path topology, where on each forwarding path, the VTEP is configured to parse the packet to obtain the private extension protocol header, and support changing a field in the private extension protocol header or executing business logic according to its own business requirement.

According to one or more embodiments of the present disclosure, the forwarding unit is further configured to, on each forwarding path, the VTEP is configured to: on each forwarding path, the VTEP is configured to support changing a business information identification bit corresponding to a node identification in the private extension protocol header according to its own node identification.

According to one or more embodiments of the present disclosure, the traffic type identification includes multiple values in a preset value range, and one value corresponds to one traffic type identification. Accordingly, the step in which the parsing unit configures the business type identification in the private extension protocol header to the business type corresponding to the target traffic specifically includes: if the business type corresponding to the target traffic is a no-type, configuring the business type identification in the private extension protocol header to 0×00; if the business type corresponding to the target traffic is a traffic mirror type, configuring the business type identification in the private extension protocol header to 0×01; and if the business type corresponding to the target traffic is a cross-network traffic type, configuring the business type identification in the private extension protocol header to 0×02, where the cross-network traffic type includes a cross-Virtual Private Cloud (VPC) network traffic type.

According to a third aspect, one or more embodiments of the present disclosure provide an electronic device, including: at least one processor and a memory, where
the memory stores computer-executable instructions; and
the at least one processor executes the computer-executable instructions stored in the memory, to enable the at least one processor to perform the packet forwarding method based on a cloud network according to the first aspect and various possible designs of the first aspect.

According to a fourth aspect, one or more embodiments of the present disclosure provide a computer-readable storage medium. The computer-readable storage medium stores computer-executable instructions, and a processor, when executing the computer-executable instructions, implements the packet forwarding method based on a cloud network according to the first aspect and various possible designs of the first aspect.

In a fifth aspect, one or more embodiments of the present disclosure provide a computer program product, including a computer program. The computer program, when executed by a processor, implements the packet forwarding method based on a cloud network according to the first aspect and various possible designs of the first aspect.

The above description is only preferred embodiments of the present disclosure and an explanation of the applied technical principles. Those skilled in the art should understand that the scope of disclosure involved in the present disclosure is not limited to the technical solutions formed by the specific combination of the above-mentioned technical features, and should also cover other technical solutions formed by any combination of the above-mentioned technical features or equivalent features thereof without departing from the above-mentioned disclosed concept, such as a technical solution formed by replacing the above-mentioned features with the technical features with similar functions disclosed in the present disclosure (but not limited to).

In addition, although various operations are depicted in a specific order, this should not be understood as requiring these operations to be performed in the specific order shown or in a sequential order. Under certain circumstances, multitasking and parallel processing may be advantageous. Similarly, although several specific implementation details are included in the above discussion, these should not be construed as limiting the scope of the present disclosure. Certain features that are described in the context of separate embodiments may also be implemented in combination in a single embodiment. Conversely, various features that are described in the context of a single embodiment may also be implemented in multiple embodiments separately or in any suitable sub-combination.

Although the subject matter has been described in language specific to structural features and/or logical actions of the method, it should be understood that the subject matter defined in the appended claims is not necessarily limited to the specific features or actions described above. Rather, the specific features and actions described above are merely example forms of implementing the claims.

I/We claim:

1. A packet forwarding method based on a cloud network, comprising:
receiving a first packet sent by a source virtual machine to a destination virtual machine, the first packet being generated by encapsulating target traffic based on an Ethernet protocol;
parsing the first packet, replacing an Ethernet protocol header of the first packet with a preset private extension protocol header, setting each field in the private extension protocol header according to a business requirement, and performing encapsulation through a virtual extensible local area network (VXLAN) protocol to generate a second packet; and
forwarding the target traffic based on the second packet.

2. The method of claim 1, wherein the private extension protocol header comprises a protocol identification, a protocol version identification, a traffic type identification, a business identification, and a storable field for storing business information.

3. The method of claim 1, wherein setting each field in the private extension protocol header according to the business requirement comprises:
configuring a protocol identification in the private extension protocol header to a preset fixed value, the preset fixed value being used to identify a private protocol;
configuring a protocol version number in the private extension protocol header to a version of the private protocol;
configuring a business type identification in the private extension protocol header to a business type corresponding to the target traffic; and
configuring a business information identification bit in the private extension protocol header, such that the business information identification bit carries node information on which a target traffic forwarding process depends.

4. The method of claim 1, wherein the method further comprises:
receiving and parsing a third packet, replacing a private extension protocol header in the third packet with an Ethernet protocol header, setting a source MAC thereof to a virtual MAC of a virtual switch and setting a destination MAC to a MAC of a tenant network card to generate a fourth packet, and forwarding the fourth packet to the destination virtual machine.

5. The method of claim 1, wherein forwarding the target traffic based on the second packet comprises:
forwarding the second packet to a next VXLAN-protocol-based traffic exchange node VTEP based on a forwarding path topology, wherein on each forwarding path, the VTEP is configured to parse a packet to obtain the private extension protocol header, and support changing a field in the private extension protocol header or executing business logic according to its own business requirement.

6. The method of claim 5, wherein the method further comprises: on each forwarding path, the VTEP is configured to support changing a business information identification bit corresponding to a node identification in the private extension protocol header according to its own node identification.

7. The method of claim 3, wherein the traffic type identification comprises multiple values in a preset value range, and one value corresponds to one traffic type identification, and
correspondingly, configuring the business type identification in the private extension protocol header to the business type corresponding to the target traffic comprises:
in response to the business type corresponding to the target traffic being a no-type, configuring the business type identification in the private extension protocol header to 0×00;
in response to the business type corresponding to the target traffic being a traffic mirror type, configuring the business type identification in the private extension protocol header to 0×01; and
in response to the business type corresponding to the target traffic being a cross-network traffic type, configuring the business type identification in the private extension protocol header to 0×02, wherein the cross-network traffic type comprises a cross-Virtual Private Cloud (VPC) network traffic type.

8. An electronic device, comprising: a processor and a memory, wherein the memory stores computer-executable instructions; and the computer-executable instructions, when executed by the processor, cause the processor to:
receive a first packet sent by a source virtual machine to a destination virtual machine, the first packet being generated by encapsulating target traffic based on an Ethernet protocol;
parse the first packet, replace an Ethernet protocol header of the first packet with a preset private extension protocol header, set each field in the private extension protocol header according to a business requirement, and perform encapsulation through a virtual extensible local area network (VXLAN) protocol to generate a second packet; and
forward the target traffic based on the second packet.

9. The electronic device of claim 8, wherein the private extension protocol header comprises a protocol identification, a protocol version identification, a traffic type identification, a business identification, and a storable field for storing business information.

10. The electronic device of claim 8, wherein the computer instructions for setting each field in the private extension protocol header according to the business requirement further cause the processor to:
configure a protocol identification in the private extension protocol header to a preset fixed value, the preset fixed value being used to identify a private protocol;
configure a protocol version number in the private extension protocol header to a version of the private protocol;
configure a business type identification in the private extension protocol header to a business type corresponding to the target traffic; and
configure a business information identification bit in the private extension protocol header, such that the business information identification bit carries node information on which a target traffic forwarding process depends.

11. The electronic device of claim 8, wherein the computer instructions further cause the processor to:
receive and parse a third packet, replace a private extension protocol header in the third packet with an Ethernet protocol header, set a source MAC thereof to a virtual MAC of a virtual switch and set a destination MAC to a MAC of a tenant network card to generate a fourth packet, and forward the fourth packet to the destination virtual machine.

12. The electronic device of claim 8, wherein the computer instructions for forwarding the target traffic based on the second packet further cause the processor to:
forward the second packet to a next VXLAN-protocol-based traffic exchange node VTEP based on a forwarding path topology, wherein on each forwarding path, the VTEP is configured to parse a packet to obtain the private extension protocol header, and support changing a field in the private extension protocol header or executing business logic according to its own business requirement.

13. The electronic device of claim 12, wherein on each forwarding path, the VTEP is configured to support changing a business information identification bit corresponding to a node identification in the private extension protocol header according to its own node identification.

14. The electronic device of claim 10, wherein the traffic type identification comprises multiple values in a preset value range, and one value corresponds to one traffic type identification, and
correspondingly, the computer instructions for configuring the business type identification in the private extension protocol header to the business type corresponding to the target traffic further cause the processor to:
in response to the business type corresponding to the target traffic being a no-type, configure the business type identification in the private extension protocol header to 0×00;
in response to the business type corresponding to the target traffic being a traffic mirror type, configure the business type identification in the private extension protocol header to 0×01; and
in response to the business type corresponding to the target traffic being a cross-network traffic type, configure the business type identification in the private extension protocol header to 0×02, wherein the cross-network traffic type comprises a cross-Virtual Private Cloud (VPC) network traffic type.

15. A non-transitory computer-readable storage medium, wherein the non-transitory computer-readable storage medium stores computer-executable instructions, and the computer-executable instructions, when executed by a processor, cause the processor to:
receive a first packet sent by a source virtual machine to a destination virtual machine, the first packet being generated by encapsulating target traffic based on an Ethernet protocol;
parse the first packet, replace an Ethernet protocol header of the first packet with a preset private extension protocol header, set each field in the private extension protocol header according to a business requirement, and perform encapsulation through a virtual extensible local area network (VXLAN) protocol to generate a second packet; and
forward the target traffic based on the second packet.

16. The non-transitory computer-readable storage medium of claim 15, wherein the private extension protocol header comprises a protocol identification, a protocol version identification, a traffic type identification, a business identification, and a storable field for storing business information.

17. The non-transitory computer-readable storage medium of claim 15, wherein the computer instructions for setting each field in the private extension protocol header according to the business requirement further cause the processor to:
configure a protocol identification in the private extension protocol header to a preset fixed value, the preset fixed value being used to identify a private protocol;
configure a protocol version number in the private extension protocol header to a version of the private protocol;
configure a business type identification in the private extension protocol header to a business type corresponding to the target traffic; and
configure a business information identification bit in the private extension protocol header, such that the business information identification bit carries node information on which a target traffic forwarding process depends.

18. The non-transitory computer-readable storage medium of claim 15, wherein the computer instructions further cause the processor to:
receive and parse a third packet, replace a private extension protocol header in the third packet with an Ethernet protocol header, set a source MAC thereof to a virtual MAC of a virtual switch and set a destination MAC to a MAC of a tenant network card to generate a fourth packet, and forward the fourth packet to the destination virtual machine.

19. The non-transitory computer-readable storage medium of claim 15, wherein the computer instructions for forwarding the target traffic based on the second packet further cause the processor to:
forward the second packet to a next VXLAN-protocol-based traffic exchange node VTEP based on a forwarding path topology, wherein on each forwarding path, the VTEP is configured to parse a packet to obtain the private extension protocol header, and support changing a field in the private extension protocol header or executing business logic according to its own business requirement.

20. The non-transitory computer-readable storage medium of claim 19, wherein on each forwarding path, the VTEP is configured to support changing a business information identification bit corresponding to a node identification in the private extension protocol header according to its own node identification.
